(19) United States
(12) Patent Application Publication
(10) Pub. No.: US 2021/0134048 A1
(43) Pub. Date: May 6, 2021

(54) COMPUTER DEVICE AND METHOD FOR GENERATING SYNTHESIZED DEPTH MAP

(71) Applicant: Institute For Information Industry, Taipei (TW)

(72) Inventors: Ming-Fang WENG, Taipei (TW); Bo-Chih CHEN, Taipei (TW)

(21) Appl. No.: 16/791,613

(22) Filed: Feb. 14, 2020

(30) Foreign Application Priority Data
Nov. 5, 2019 (TW) 108140107

(51) Int. Cl. G06T 15/10; H04N 13/271; H04N 13/128; H04N 13/111

(52) U.S. Cl. CPC G06T 15/10; H04N 13/271; H04N 2013/0081; H04N 13/111; H04N 13/128

(57) ABSTRACT

A computer device calculates an estimated depth for each of non-feature points of a sparse point cloud map of an image according to feature-point depths of feature points of the sparse point cloud map and pixel depths of pixels of an image depth map of the image, and generates a synthesized depth map according to the feature-point depths and the estimated depths.

### PRIORITY

This application claims priority to Taiwan Patent Application No. 108140107 filed on Nov. 5, 2019, which is hereby incorporated by reference in its entirety.

### FIELD

Embodiments of the present invention relate to a computer device and a method for image processing. More specifically, embodiments of the present invention relate to a computer device and a method for generating a synthesized depth map.

### BACKGROUND

In the field of image processing, depth information of an image is often required to implement applications such as image synthesis, augmented reality (AR), mixed reality (MR). In some cases, an image depth map of an image may be generated through various computer algorithms, thereby obtaining depth information of the image. In general, an image depth map comprises the depths of all pixels in an image, wherein the differences between the depths of adjacent pixels may be correct, but the absolute depths of the respective pixels may not be correct. Therefore, the depth information provided by the image depth map is characterized by high integrity and low accuracy. In some cases, a sparse point cloud map of an image may be generated through synchronous positioning and map reconstruction techniques, thereby obtaining depth information of the image. In general, a sparse point cloud map can provide the depths of the feature points in the image with high accuracy, but nothing for the depths of non-feature points. Therefore, the depth information provided by the sparse point cloud map is characterized by high accuracy and low integrity.

As described above, the application of the image depth map and that of the sparse point cloud map are both limited. Generally, the image depth map is unfavorable where the sparse point cloud map is favorable, and vice versa. In view of this, it is necessary to improve the traditional methods for providing image-depth information.

### SUMMARY

The disclosure includes a computer device. The computer device may comprise a storage and a processor which are electrically connected to each other. The storage may be configured to store a sparse point cloud map of an image and an image depth map of the image, wherein the sparse point cloud map comprises a plurality of feature points each of which has a feature-point depth and a plurality of non-feature points, and the image depth map comprises a plurality of pixels each of which has a pixel depth. The processor may be configured to calculate an estimated depth of each of the non-feature points according to the pixel depths and the feature-point depths, and generate a synthesized depth map according to the feature-point depths and the estimated depths.

The disclosure further includes a method for generating a synthesized depth map which may comprise the following steps: calculating, by a computer device, an estimated depth for each of a plurality of non-feature points of a sparse point cloud map of an image according to a plurality of pixel depths of a plurality of pixels comprised by an image depth map of the image, and a plurality of feature-point depths of a plurality of feature points comprised by the sparse point cloud map; and generating, by the computer device, the synthesized depth map of the image according to the feature-point depths and the estimated depths.

The computer device retains the feature-point depths of high accuracy from the sparse point cloud map, and calculates the estimated depths of the non-feature points in the sparse point cloud map according to these feature-point depths and the pixel depths of high integrity from the image depth map. Therefore, the synthetic depth map generated according to these feature-point depths and these estimated depths of the non-feature points can provide depth information with high accuracy and high integrity. In addition, because the synthetic depth map is characterized by high accuracy due to the sparse point cloud map and high integrity due to the image depth map, the synthetic depth map is also characterized by higher applicability.

The descriptions above are not intended to limit the present invention, but merely to outline the solvable technical problems, the usable technical means, and the achievable technical effects for a person having ordinary skill in the art (PHOSITA) to preliminarily understand the present invention. According to the attached drawings and the following detailed description, the PHOSITA can further understand the details of various embodiments of the present invention.

### BRIEF DESCRIPTION OF THE DRAWINGS

The drawings are provided for describing various embodiments, in which:

FIG. 1 illustrates a computer device for generating a synthesized depth map of an image according to some embodiments;

FIG. 2 illustrates a procedure of generating a synthesized depth map of an image by the computer device of FIG. 1 according to some embodiments;

FIG. 3 illustrates bar graphs of some pixel depths of an image depth map, a sparse point cloud map and a synthesized depth map of an image according to some embodiments; and

FIG. 4 illustrates a method for generating a synthesized depth map according to some embodiments.

### DETAILED DESCRIPTION

In the following description, the present invention will be explained with reference to certain example embodiments thereof. However, these example embodiments are not intended to limit the present invention to be implemented only in the operations, environment, applications, examples, embodiments, structures, processes, or steps described in these example embodiments. In the attached drawings, elements unrelated to the present invention are omitted from depiction but may be implied in the drawings; and dimensions of elements and proportional relationships among individual elements in the attached drawings are only exemplary examples but not intended to limit the present invention. Unless stated particularly, same (or similar) element symbols may correspond to same (or similar) elements in the following description. Unless stated particularly, the number of each element described hereinafter may be one or more while being implementable.

Terms used in the present disclosure are only for the purpose of describing embodiments and are not intended to limit the invention. Singular forms “a,” “an,” and “the” are intended to include the plural forms as well, unless the context clearly indicates otherwise. Terms such as “comprises” and/or “comprising” specify the presence of stated features, integers, steps, operations, elements, and/or components, but do not preclude the presence of one or more other features, integers, steps, operations, elements, components, and/or combinations thereof. The term “and/or” includes any and all combinations of one or more associated listed items.

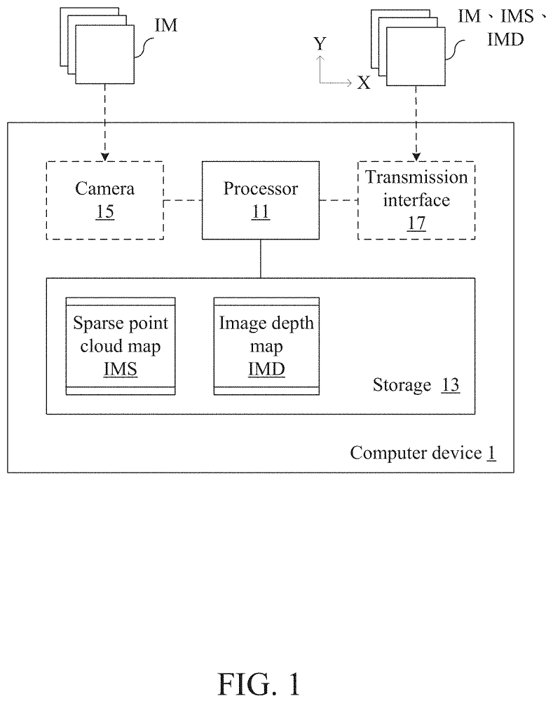

FIG. 1 illustrates a computer device for generating a synthesized depth map of an image according to some embodiments. The contents of FIG. 1 are shown only for the purpose of illustrating embodiments of the present invention and do not intent to limit the present invention. The computer device 1 shown in FIG. 1 may be an electronic device with computer functions such as a server, a notebook computer, a tablet computer, a desktop computer, and a mobile device. The computer device 1 may also be a computer chip configured in various electronic devices.

Referring to FIG. 1, the computer device 1 may basically comprise a processor 11 and a storage 13 which are electrically connected to each other. The processor 11 may comprise one or more microprocessors or microcontrollers with signal processing functions. A microprocessor or microcontroller is a programmable special integrated circuit that has the functions of calculation, storage, output/input, etc., and can receive and process various coding instructions, thereby performing various logic calculations and arithmetic operations, and outputting the corresponding calculated result. The processor 11 may perform various operations for an input image IM. For example, in some embodiments, the processor 11 may calculate a sparse point cloud map IMS and/or an image depth map IMD of the image IM, and generate a synthesized depth map of the image IM based on the sparse point cloud map IMS and the image depth map IMD of the image IM (as described in detail later).

The storage 13 may comprise various storage units. For example, the storage 13 may comprise a primary memory (also referred to as a main memory or an internal memory), which is directly connected to a central processing unit (CPU). In addition to the primary memory, in some embodiments, the storage 13 may also comprise a secondary memory (also referred to as an external memory or an auxiliary memory), which is connected to the CPU through the memory's I/O channels. The secondary memory may be, for example, various types of hard disks, optical disks. In addition to the primary memory and the secondary memory, in some embodiments, the storage 13 may also comprise a third-level memory, such as a storage device that can be directly inserted into or removed from a computer, e.g., a flash drive. In some embodiments, the storage 13 may further comprise a cloud storage unit. The storage 13 may store data generated by the computer device 1 and various data inputted to the computer device 1, such as the image IM, the sparse point cloud map IMS of the image IM, and the image depth map IMD of the image IM.

In some embodiments, the computer device 1 may optionally comprise a camera 15 electrically connected to the processor 11. The camera 15 may be various devices with the functions of dynamically and/or statically capturing images, such as a digital camera, a video recorder, or various mobile devices with photographing functions. In addition, the camera 15 may comprise a wired connector and/or a wireless connector which is used to connect itself to the computer device 1 in a wired or a wireless manner. In some embodiments, the camera 15 may also be a camera module disposed in a computer chip. The camera 15 may be configured to capture the image IM and other images related to the image IM.

In some embodiments, the computer device 1 may also comprise a transmission interface 17 electrically connected to the processor 11. The transmission interface 17 may comprise various input/output elements for receiving data from the outside and outputting data to the outside. The transmission interface 17 may also comprise various communication elements such as an Ethernet communication element, an Internet communication element, in order to connect with various external electronic devices or servers for data transmission. Through the transmission interface 17, the computer device 1 may receive the image IM, the sparse point cloud map IMS and/or the image depth map IMD of the image IM from the outside and store them into the storage 13.

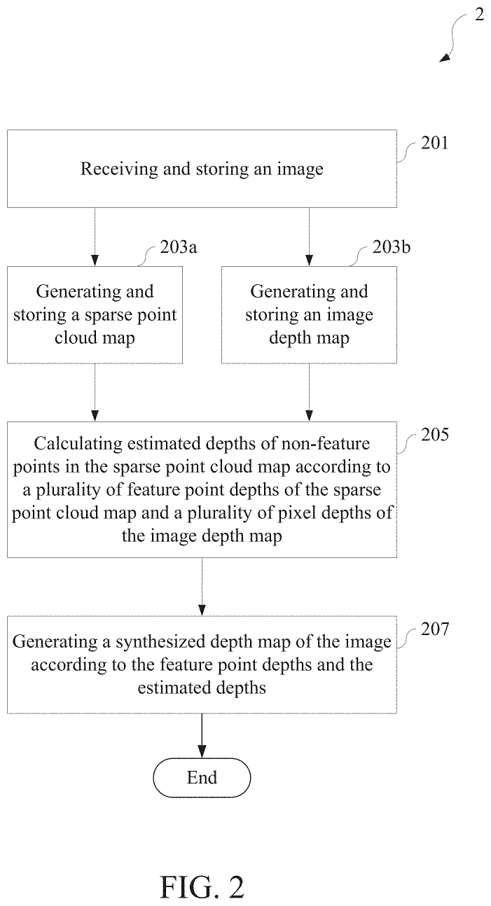

FIG. 2 illustrates a procedure of generating a synthesized depth map of an image by the computer device of FIG. 1 according to some embodiments. The contents of FIG. 2 are shown only for the purpose of illustrating embodiments of the present invention and do not intent to limit the present invention.

In the procedure 2, first, the computer device 1 may receive and store the image IM and/or other image(s) related to the image IM (labeled as the process 201). Specifically, in different embodiments, the computer device 1 may capture the image IM and the other related image(s) through the camera 15 and then store them into the storage 13, or may receive the image IM and the other related image(s) from the outside through the transmission interface 17 and then store them into the storage 13. The image IM and the other related image(s) may refer to images under different angles of shot (i.e., the images are shot by the camera at different positions with different lines of sight) in a field.

In some embodiments, after obtaining the image IM and the other related image(s), the computer device 1 may generate a sparse point cloud map IMS of the image IM and store the sparse point cloud map IMS into the storage 13 (labeled as the process 203a), wherein the sparse point cloud map IMS of the image IM may comprise a plurality of feature points and a plurality of non-feature points, and each of the feature points has a feature-point depth. For example, the processor 11 of the computer device 1 may identify the common feature points in both of the image IM and the other related image(s), and calculate the parallax for each of the common feature points among these images based on the principle of similar triangles to calculate a feature-point depth of each of the common feature points. Then, the processor 11 may generate and store the sparse point cloud map IMS of the image IM according to these feature-point depths. In different embodiments, the computer device 1 can calculate the sparse point cloud map of the image IM through various algorithms such as an ORB-SLAM2 algorithm, a Stereo-Matching algorithm, or an LSD-slam algorithm.

In some embodiments, the computer device 1 may also receive the sparse point cloud map IMS of the image IM directly from the outside through the transmission interface 17 and store it into the storage 13.

On the other hand, after obtaining the image IM, the computer device 1 may generate an image depth map IMD of the image IM and store the image depth map IMD into the storage 13 (labeled as the process 203b), wherein the image depth map IMD comprises a plurality of pixels, and each of the pixels has a pixel depths. In other words, all or most of the pixels in the image depth map IMD have respective pixel depths. For example, the computer device 1 may first convert the format of the image IM into an RGB format or a grayscale format, and then input the image IM into various machine learning models to generate an image depth map IMD of the image IM. The machine learning models can be generated by training various existing image depth data sets (for example but not limited to: a KITTI data set and an NYU-depth data set). In different embodiments, the computer device 1 may use various algorithms to calculate the image depth map IMD of the image IM such as a Fast-Depth algorithm or a DF-Net algorithm.

In some embodiments, the computer device 1 may also receive the image depth map IMD of the image IM from the outside directly through the transmission interface 17 and store it into the storage 13.

In some embodiments, the computer device 1 can perform the process 203a and the process 203b shown in FIG. 2 simultaneously. In some embodiments, the computer device 1 may perform the process 203b after finishing the process 203a. In some embodiments, the computer device 1 may perform the process 203a after finishing the process 203b.

After the process 203a and 203b are completed, the processor 13 of the computer device 1 may calculate the estimated depths of the non-feature points in the sparse point cloud map IMS according to a plurality of feature-point depths of the sparse point cloud map IMS and a plurality of pixel depths of the image depth map IMD (labeled as the process 205).

In some embodiments, in the process 205, the processor 11 may calculate the estimated depths of the non-feature points in the sparse point cloud map IMS through a gradient-domain operation. In detail, the processor 11 may calculate a plurality of depth gradients of a plurality of pixels of the image depth map IMD according to the plurality of pixel depths provided by the image depth map IMD, and then calculate the estimated depths of the non-feature points in the sparse point cloud map IMS according to the depth gradients of the pixels in the image depth map IMD and the feature-point depths provided by the sparse point cloud map IMS under the condition that a difference between the depth gradients of the non-feature points in the sparse point cloud map IMS and the depth gradients of the corresponding pixels in the image depth map IMD is minimized.

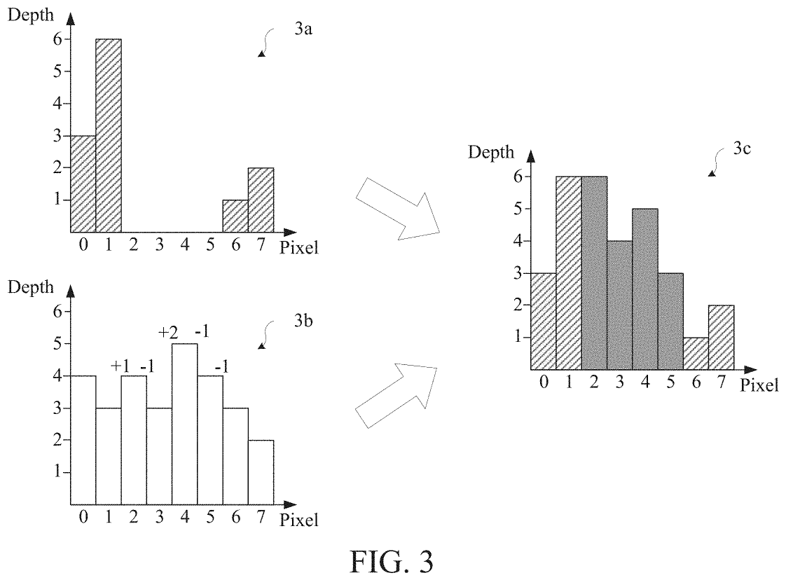

The processor 11 may calculate the estimated depths of the non-feature points in the sparse point cloud map IMS through a one-dimensional gradient-domain operation or a two-dimensional gradient-domain operation. In the following, FIG. 3 will be used as an example to explain how to calculate the estimated depths of the non-feature points in the sparse point cloud map IMS. FIG. 3 illustrates bar graphs of some pixel depths of the image depth map IMD, the sparse point cloud map IMS, and a synthesized depth map of an image according to some embodiments. The contents of FIG. 3 are shown only for the purpose of illustrating embodiments of the present invention and do not intent to limit the present invention.

Referring to FIG. 3, a bar graph 3a is provided for showing some pixels of the sparse point cloud map IMS of the image IM and their respective depths. In the bar graph 3a, the pixel “0,” the pixel “1,” the pixel “6,” and the pixel “7” represent the feature points of the sparse point cloud map IMS, and the pixel “2,” the pixel “3,” the pixel “4” and the pixel “5” represent the non-feature points of the sparse point cloud map IMS. In the bar graph 3a, the feature-point depths of the pixel “0,” the pixel “1,” the pixel “6,” and the pixel “7” are “3,” “6,” “1,” and “2” respectively. The pixel “2,” the pixel “3,” the pixel “4,” and the pixel “5” are non-feature points and therefore have no depth information.

Still referring to FIG. 3, another bar graph 3b is provided for showing some pixels of the image depth map IMD of the image IM and their respective depths. In the bar graph 3b, the pixels “0” to “7” have respective pixel depths which are “4,” “3,” “4,” “3,” “5,” “4,” “3,” and “2” in order. The pixels “0” to “7” shown in the bar graph 3b correspond to the pixels “0” to “7” shown in the bar graph 3a respectively.

The depths in this disclosure may be scaled in meter; however, they may also be scaled in centimeter, millimeter, yard, inch, foot, etc.

Next, the estimated depths of the pixel “2,” the pixel “3,” the pixel “4,” and the pixel “5” of the bar graph 3a which are the non-feature points are calculated. First, the processor 11 may calculate the one-dimensional depth gradients (i.e., the one-dimensional depth differences) between each of the pixels “2” to “5” and its adjacent pixels on the X-axis or Y-axis of the image depth map IMD. For example, as shown in the bar graph 3b, the depth gradient between the pixel “2” and the pixel “1” is “+1” (i.e., the pixel depth “4” of the pixel “2” minus the pixel depths “3” of the pixel “1”). Similarly, the depth gradient between the pixel “3” and the pixel “2” is “−1,” the depth gradient between the pixel “4” and the pixel “3” is “+2,” the depth gradient between the pixel “5” and the pixel “4” is “−1,” and the depth gradient between the pixel “6” and the pixel “5” is “−1.”

Next, according to the following formulas, the error value Q is defined as a difference between the depth gradients of the non-feature points in the sparse point cloud map IMS and the depth gradients of the corresponding pixels in the image depth map IMD. Here, the non-feature points in the sparse point cloud map IMS are just the pixels “2” to “5” shown in the bar graph 3a, and the corresponding pixels in the image depth map IMD are just the pixels “2” to “5” shown in the bar graph 3b. Thus, the error value Q is likewise defined as the difference between the one-dimensional depth gradients of the pixels “2” to “5” of the bar graph 3a and the one-dimensional depth gradients of the pixels “2” to “5” of the bar graph 3b.

Q=((f₂−f₁)−1)²+((f₃−f₂)−(−1))²+((f₄−f₃)−2)²+((f₅−f₄)−(−1))²+((f₆−f₅)−(−1)² (Formula 1)

where f₁˜f₆ represent the depths of the pixels “1” to “6” respectively, (f₂−f₁) is the depth gradient between the pixel “2” and the pixel “1,” and (f₃−f₂) is the depth gradient between the pixel “3” and the pixel “2,” and so on.

The pixel “1” and the pixel “6” in the bar graph 3a are the feature points and have feature-point depths of “6” and “1” (i.e., f₁=6 and f₆=1) respectively. With the given feature-point depths of “6” and “1”, Formula 1 can be expressed as follows:

Q=2f₂²+2f₃²+2f₄²+2f₅²−16f₂+6f₃−6f₄−2f₅−2f₃f₂−2f₄f₃−2f₅f₄+59 (Formula 2)

Next, the processor 11 tries to find out the values of f₂, f₃, f₄, and f₅ with the minimum error value Q. In some embodiments, as shown below, the processor 11 may solve for the minimum error value Q in the condition that the partial derivatives of f₂, f₃, f₄, and f₅ are zero:

$$\begin{matrix}\frac{\partial Q}{\partial {f}_{2}} = 4 {f}_{2} - 2 {f}_{3} - 16 = 0 & ( Formula 3 ) \\ \frac{\partial Q}{\partial {f}_{3}} = - 2 {f}_{2} + 4 {f}_{3} - 2 {f}_{4} + 6 = 0 & ( Formula 4 ) \\ \frac{\partial Q}{\partial {f}_{4}} = - 2 {f}_{3} + 4 {f}_{4} - 2 {f}_{5} - 6 = 0 & ( Formula 5 ) \\ \frac{\partial Q}{\partial {f}_{5}} = - 2 {f}_{4} + 4 {f}_{5} - 2 = 0 & ( Formula 6 )\end{matrix}$$

Formula 3, Formula 4, Formula 5, and Formula 6 may be expressed in matrix form as follows:

$$[ \begin{matrix}4 & - 2 & 0 & 0 \\ - 2 & 4 & - 2 & 0 \\ 0 & - 2 & 4 & - 2 \\ 0 & 0 & - 2 & 4\end{matrix} ] [ \begin{matrix}{f}_{2} \\ {f}_{3} \\ {f}_{4} \\ {f}_{5}\end{matrix} ] = [ \begin{matrix}16 \\ - 6 \\ 6 \\ 2\end{matrix} ] \qquad ( Formula 7 )$$

As shown below, the values of f2, f3, f4, and f5 can be obtained with a matrix operation:

$$[ \begin{matrix}{f}_{2} \\ {f}_{3} \\ {f}_{4} \\ {f}_{5}\end{matrix} ] = [ \begin{matrix}6 \\ 4 \\ 5 \\ 3\end{matrix} ] \qquad ( Formula 8 )$$

According to Formula 8, the minimum value of the error value Q can be obtained when f₂=6, f₃=4, f₄=5, and f₅=3. That is, when the estimated depths of the pixel “2,” the pixel “3,” the pixel “4,” and the pixel “5” in the bar graph 3a are “6,” “4,” “5,” and “3” respectively, the error value Q can be minimized.

Calculating the estimated depths of the non-feature points in the sparse point cloud map IMS through the gradient-domain operation as described above is not a limitation. In some embodiments, some other methods can also be used to calculate the estimated depths of the non-feature points in a sparse point cloud map IMS.

In some embodiments, a two-dimensional depth-gradient operation may be adopted, and thus the processor 11 may calculate the two-dimensional depth gradients (i.e., two-dimensional depth differences) between each of the pixels “2” to “5” and its adjacent pixels on the X-axis and Y-axis of the image depth map IMD. In such embodiments, Formula 1 to Formula 6 may be modified into two-dimensional formulas, and then similar operations can be performed to obtain the estimated depths of each of the pixels “2” to “5.”

After the process 205 is completed, the computer device 1 may generate a synthesized depth map of the image IM according to the feature-point depths of the feature points in the sparse point cloud map IMS and the estimated depths of the non-feature points in the sparse point cloud map IMS (labeled as the process 207). Referring to FIG. 3, the bar graph 3c is provided for showing some pixels of the synthesized depth map of the image IM and their depths. In detail, in the bar graph 3c, the processor 11 retains the feature-point depths (i.e., “3,” “6,” “1,” and “2” respectively) of the feature points (i.e., the pixel “0,” the pixel “1,” the pixel “6,” and the pixel “7” respectively) in the bar graph 3a, and determine the depths of the pixel “2,” the pixel “3,” the pixel “4,” and the pixel “5” as the estimated depths (i.e., “6,” “4,” “5,” and “3”) which has been calculated for the non-feature points in the sparse point cloud map IMS.

The processes 201, 203a, and 203b shown in FIG. 3 are optional. For example, in the case that the sparse point cloud map IMS and the image depth map IMD of the image IM have been received from the outside through the transmission interface 17, the computer device 1 may not perform the process 201, the process 203a, and the process 203b, and may just perform the process 205 and the process 207 to generate the synthesized depth map of the image IM. For another example, in the case that the sparse point cloud map IMS of the image IM has been received from the outside through the transmission interface 17, the computer device 1 may not perform the process 203a; and in the case that the image depth map IMD of the image IM has been received from the outside through the transmission interface 17, the computer device 1 may not perform the process 203b.

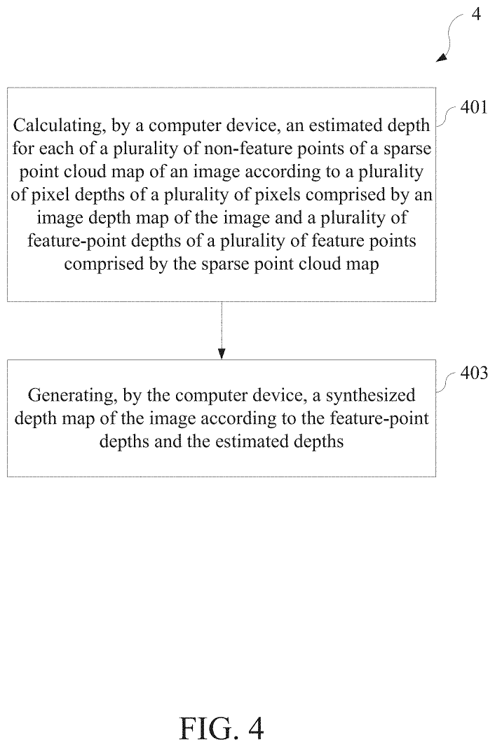

FIG. 4 illustrates a method for generating a synthesized depth map according to some embodiments. The contents of FIG. 4 are shown only for the purpose of illustrating embodiments of the present invention and do not intent to limit the present invention.

Referring to FIG. 4, the method 4 for generating the synthesized depth map may comprise the following steps: calculating, by a computer device, an estimated depth for each of a plurality of non-feature points of a sparse point cloud map of an image according to a plurality of pixel depths of a plurality of pixels comprised by an image depth map of the image and a plurality of feature-point depths of a plurality of feature points comprised by the sparse point cloud map (labeled as the step 401); and generating, by the computer device, the synthesized depth map of the image according to the feature-point depths and the estimated depths (labeled as the step 403).

In some embodiments, the step 401 may further comprise the following steps: calculating a plurality of depth gradients of the pixels according to the pixel depths; and calculating the estimated depths according to the depth gradients of the pixels and the feature-point depths under the condition that a difference between depth gradients of the non-feature points and depth gradients of corresponding pixels in the image depth map is minimized.

In some embodiments, the method 4 for generating the synthesized depth map may further comprise the following steps: capturing, by the computer device, the image in a field; and calculating the image depth map of the image through one of a Fast-Depth algorithm and a DF-Net algorithm and storing the image depth map, by the computer device.

In some embodiments, the method 4 for generating the synthesized depth map may further comprise the following steps: capturing, by the computer device, the image and one or more other related images with different angles of shot in a field; and calculating the sparse point cloud map of the image according to the image and the other related image(s) through one of an ORB-SLAM2 algorithm, a Stereo-Matching algorithm, and an LSD-slam algorithm and storing the sparse point cloud map, by the computer device.

In some embodiments, all of the above steps of the method 4 for generating the synthesized depth map may be performed by the computer device 1. In addition to the above steps, the method 4 for generating the synthesized depth map may also comprise other steps corresponding to those described in the above embodiments of the computer device 1. The PHOSITA can understand these other steps according to the above description of the computer device 1, and therefore these other steps are not described in detail.

The above disclosure is related to the detailed technical contents and inventive features thereof for some embodiments of the present invention, but such disclosure is not to limit the present invention. The PHOSITA may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A computer device, comprising:
a storage, being configured to store a sparse point cloud map of an image and an image depth map of the image, wherein the sparse point cloud map comprises a plurality of feature points and a plurality of non-feature points, each of the feature points has a feature-point depth, the image depth map comprises a plurality of pixels, and each of the pixels has a pixel depth; and
a processor, being electrically connected to the storage, and being configured to calculate an estimated depth of each of the non-feature points according to the pixel depths and the feature-point depths, and generate a synthesized depth map according to the feature-point depths and the estimated depths.

2. The computer device of claim 1, wherein the process that the processor calculates the estimated depths comprises:
calculating a plurality of depth gradients of the pixels according to the pixel depths, and calculating the estimated depths according to the depth gradients of the pixels and the feature-point depths under the condition that a difference between depth gradients of the non-feature points and depth gradients of corresponding pixels in the image depth map is minimized.

3. The computer device of claim 1, further comprising:
a camera, being electrically connected to the processor, and being configured to capture the image in a field;
wherein the processor is further configured to calculate the image depth map of the image through one of a Fast-Depth algorithm and a DF-Net algorithm, and store the image depth map into the storage.

4. The computer device of claim 1, further comprising:
a camera, being electrically connected to the processor, and being configured to capture the image and one or more other related images with different angles of shot in a field;
wherein the processor is further configured to calculate the sparse point cloud map of the image according to the image and the other related image(s) through one of an ORB-SLAM2 algorithm, a Stereo-Matching algorithm, and an LSD-slam algorithm, and store the sparse point cloud map into the storage.

5. A method for generating a synthesized depth map, comprising:
calculating, by a computer device, an estimated depth for each of a plurality of non-feature points of a sparse point cloud map of an image according to a plurality of pixel depths of a plurality of pixels comprised by an image depth map of the image, and a plurality of feature-point depths of a plurality of feature points comprised by the sparse point cloud map; and
generating, by the computer device, the synthesized depth map of the image according to the feature-point depths and the estimated depths.

6. The method for generating the synthesized depth map of claim 5, wherein the step of calculating the estimated depths further comprises:
calculating a plurality of depth gradients of the pixels according to the pixel depths, and
calculating the estimated depths according to the depth gradients of the pixels and the feature-point depths under the condition that a difference between depth gradients of the non-feature points and depth gradients of corresponding pixels in the image depth map is minimized.

7. The method for generating the synthesized depth map of claim 5, further comprising:
capturing, by the computer device, the image in a field; and
calculating the image depth map of the image through one of a Fast-Depth algorithm and a DF-Net algorithm, and storing the image depth map, by the computer device.

8. The method for generating the synthesized depth map of claim 5, further comprising:
capturing, by the computer device, the image and one or more other related images with different angles of shot in a field; and
calculating the sparse point cloud map of the image according to the image and the other related image(s) through one of an ORB-SLAM2 algorithm, a Stereo-Matching algorithm, and an LSD-slam algorithm, and storing the sparse point cloud map, by the computer device.
